(19) United States
(12) Patent Application Publication
(10) Pub. No.: US 2024/0400318 A1
(43) Pub. Date: Dec. 5, 2024

(54) METHOD OF STACKING MULTIPLE BOARD GROUPS

(71) Applicant: Automated Industrial Technologies, Inc., Forest, VA (US)

(72) Inventors: Gary SILL, Forest, VA (US); Shawn LITTLE, Lynchburg, VA (US)

(73) Assignee: Automated Industrial Technologies, Inc., Forest, VA (US)

(21) Appl. No.: 18/680,018

(22) Filed: May 31, 2024

Related U.S. Application Data
(60) Provisional application No. 63/470,036, filed on May 31, 2023.

(51) Int. Cl. B65G 57/11; B65G 57/18

(52) U.S. Cl. CPC B65G 57/11; B65G 57/18

(57) ABSTRACT

The present invention provides a method and mechanism to build individual stacks of boards and collect them as a layer from a stream of single boards in the same orientation and direction positioned between a board feeding mechanism such as an unscrambler machine and a board handling mechanism such as a stacking machine in the pallet industry.

### RELATED APPLICATION

This application claims the benefit of U.S. Provisional Application Ser. No. 63/470,036, filed May 31, 2023, entitled “Method Of Stacking Multiple Board Groups,” which is incorporated herein by reference in its entirety.

### FIELD OF THE INVENTION

This patent application provides a description of a method and mechanism to build individual stacks of boards and collect them as a layer from a stream of single boards in the same orientation and direction positioned between a board feeding mechanism such as an unscrambler machine and a board handling mechanism such as a stacking machine in the pallet industry.

### BACKGROUND OF THE INVENTION

In the lumber industry, wood is processed along its length to reduce the size of the cutting tools required to produce the desired cross-sectional shape. After the processes of shaping and sizing have been completed the resulting boards are transported with the length of board across the conveyor (direction of travel). Dimensional lumber is produced, inspected and graded to determine the quality of the board and then sorted according to its grade. The better the grade of lumber the more expensive the bundles of dimensional boards are. With the better grades of dimensional lumber (2×4, 2×6, 2×8, etc.) the allowable deviations from a complete cross section, flatness and straightness are not major impediments to handling the boards efficiently at higher speeds.

The pallet industry takes standard size lumber, converts it into specific board dimensions and feeds the boards into the pallet assembly operation. A conventional pallet is shown in FIG. 1. To control and/or reduce the finished pallet cost, there is an increasing incentive to use the lower grades of dimensional lumber for the components. In the pallet industry, the dimensional lumber is processed into different lengths, widths and thicknesses resulting in multiple boards from one dimensional piece. The production at higher speeds of a specific width and thickness from larger dimension boards for a specific pallet size or other product requirement amplifies the need for high speed, reliable and efficient stacking. This need can be addressed with (a) more people manually stacking, (b) faster automated stacking machines, (c) multiple slower stacking machine splitting the load, or (d) a combination thereof.

In general, boards are stacked individually or in groups by hand into layers or automatically one complete layer at a time by machine. Machine stacking is accomplished by placing a layer on top of a stack, dropping a layer on the top of a stack or lifting a layer up to the bottom of the stack. All of these methods are constrained by the creation of the layer, movement of a layer into position over/under the stack and the time to add the layer to the stack. Increased stacking speeds of automated equipment reduce the time required to create a layer, move the layer into position and place the layer. Some equipment is designed so that two or three of the steps can be overlapped to increase capacity.

The present art highlights the fact that the creation of a single layer is the critical step in the automatic stacking process. In stacking machines such as the Automated Industrial Technologies M2L Machine shown in FIGS. 2 and 3, a single layer is created by stopping the first board on the infeed chain or belts. The second board runs into the first and stops edge to edge. The following boards repeat the process with the chain or belt continuing to move under all the boards in the layer. Each board is trying to push the board in front of it forward. Within the limits of thickness variation, overhead guides are used to keep the whole layer flat and edge to edge. When the length of the layer (number of boards) is accumulated, the layer can be added to the stack.

The creation of multiple thickness boards from a single dimensional piece of lumber of lower grades exacerbates the variations of cross section area (wane). Missing portions of the edges of a board or boards in a layer cause skewing of the layer or a shorter layer length. Accumulating 8 to 15 boards edge to edge on a moving belt or chain requires that the boards do not overlap each other and remain parallel as much as possible. However, with half or two thirds of the thickness of a dimensional board becoming a different board, the prevention of overlapping edges is very difficult with the lower grades of lumber. This overlapping of board edges results in varying widths and thicknesses of the layers and makes the accurate positioning of each layer difficult. The resulting layers create unstable stacks or require stopping the stacking process for manual intervention. With the reduced thicknesses of the boards, the grade of the parent dimensional lumber has a direct effect on the speed and efficiency of the handling operations.

The wood processing industry, an example of which is pallet building, has developed to include several standard machine types which allow for a production line to function efficiently. All the board preparation steps run much faster than the finished pallet assembly step. The speed difference and space requirements mean than all the component boards must be accumulated in an orderly arrangement (stacked) so that they can be efficiently transferred to the final assembly step. The following narrative will be applied to the wood processing industry for the sake of illustration. Once an individual method of stacking boards has been mechanically optimized and the number of layers per minute maximized, the only way to increase the number of boards per minute is to increase the number of boards per layer placed onto the stack. U.S. Pat. No. 4,159,058 to Zimmerman discloses accumulating stacks of boards into a layer and placing the multi-board layer on the stack. However, while Zimmerman discloses multiple boards stacked on edge feeding into the stacker, it does not address how to create the stacks.

### SUMMARY OF THE INVENTION

An object of the present invention is to provide an apparatus and method to build individual stacks of boards and collect them as a layer from a stream of single boards in the same orientation and direction positioned between a board feeding mechanism such as an unscrambler machine and a board handling mechanism such as a stacking machine in the pallet industry.

Another object of the present invention is to provide a spiral or helix apparatus and method to build individual stacks of boards and collect them as a layer from a stream of single boards in the same orientation and direction positioned between a board feeding mechanism such as an unscrambler machine and a board handling mechanism such as a stacking machine in the pallet industry.

The present invention is directed to an apparatus to build individual stacks of boards and collect them as a layer from a stream of single boards inline with a conveyor or other equipment comprising a spiral at the end of the conveyor or other equipment for receiving the single boards, the spiral having a first valley and a first and second peak adjacent each side of the first valley, the first valley adapted to receive two or more single boards in stacked relation, wherein the spiral is adapted to be rotated to move the two or more single boards downstream and provide a second valley and a third and fourth peak adjacent each side of the second valley for receiving an additional two or more single boards in stacked relation, wherein at the end of the spiral multiple groups of the two or more stacked boards are positioned for forming a layer of stacked boards.

The invention in further directed to a method of using the apparatus in the pallet industry.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1 shows the components of a pallet.

FIG. 2 is a downstream view of the steps to create a stack of pallet components using the Automated Industrial Technologies (AIT) M2L Machine.

FIG. 3 is a side view of the steps to create a stack on the AIT M2L.

FIG. 4 shows the feeding of boards to a mini stacker apparatus of the invention.

FIG. 5 shows a first board in a first valley of a spiral of the mini stacker.

FIG. 6 shows two boards stacked in the first valley of the spiral.

FIG. 7 shows stacks of two boards in two valleys of the spiral.

FIG. 8 shows stacks of two boards in three valleys.

FIG. 9 shows the first stack of two boards on the exit/takeaway conveyor.

FIG. 10 shows a layer of boards accumulating downstream of the mini stacker.

FIG. 11 shows an example of a hold down flap track.

FIG. 12 shows an example of a hold down flap wheel.

FIG. 13 shows the first board entering the hold down flaps.

FIG. 14 shows the second board entering the hold down flaps and the first board advancing.

FIG. 15 shows the third board entering the hold down flaps and the first board released into the valley of the spiral.

FIG. 16 shows an example of the mini stacker with a hold down flap wheel.

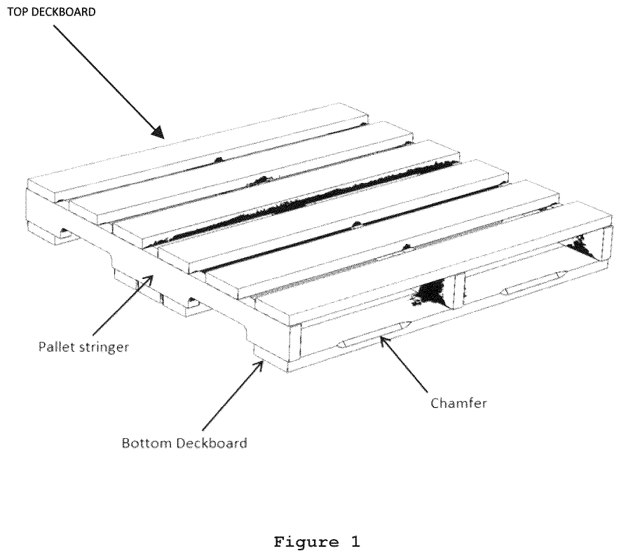

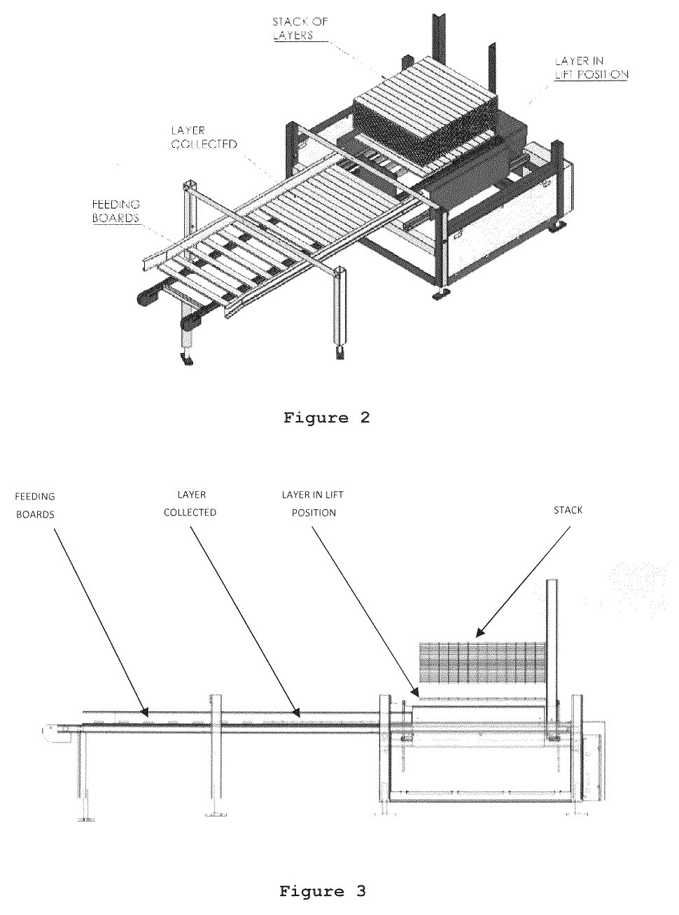

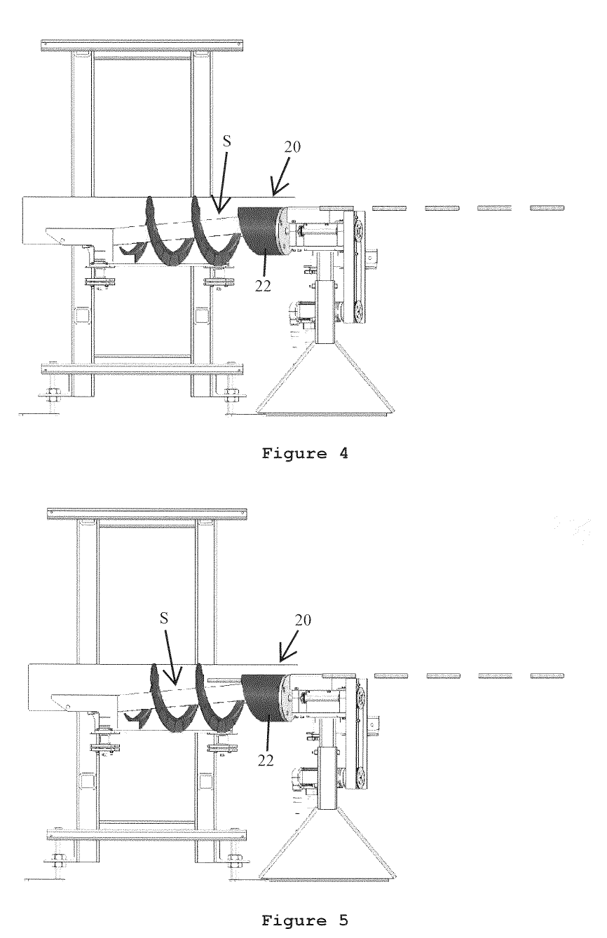

### DETAILED DESCRIPTION OF THE INVENTION

The present invention is directed to a method of using single or multiple rotating spiral or helix mechanisms that are angled slightly from the direction of board travel to create individual multi-board stacks. The spirals can be parallel or symmetrically opposed to each other and counter rotating. The spiral/helix mechanisms could be combined with either or all of (a) an inclined ramp, (b) a flap system, (c) a rotating tire, and (d) a driven set of wheels, to assist the transfer of the boards from the infeed conveyor to a first valley of the spiral. The system will accept single boards conveyed on their side (not edge) and perpendicular to the long dimension (length), deposit a second board from the conveyor on top of the first board, if needed deposit a third on top of the second and repeating as many times as possible or desired. At the end of the helix and ramp, the stacks of two or more boards high are discharged side by side to create a multi-board layer. This multi-board layer can then be moved over and placed, dropped or lifted into/onto a stack. This increases the quantity of boards per minute that can be stacked and accepts lower grade parent lumber without affecting efficiency.

The invention will be explained in the following description in reference to the accompanying figures.

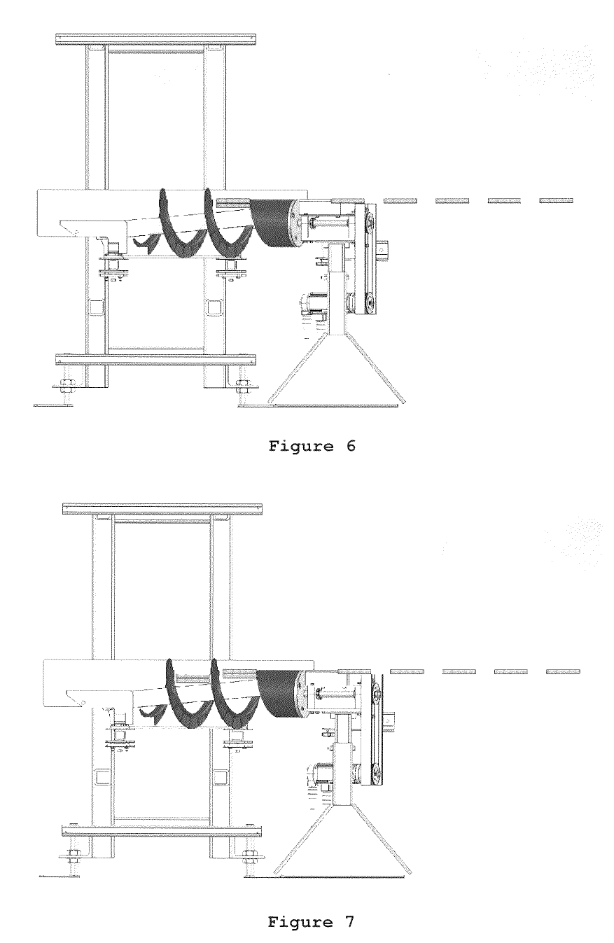

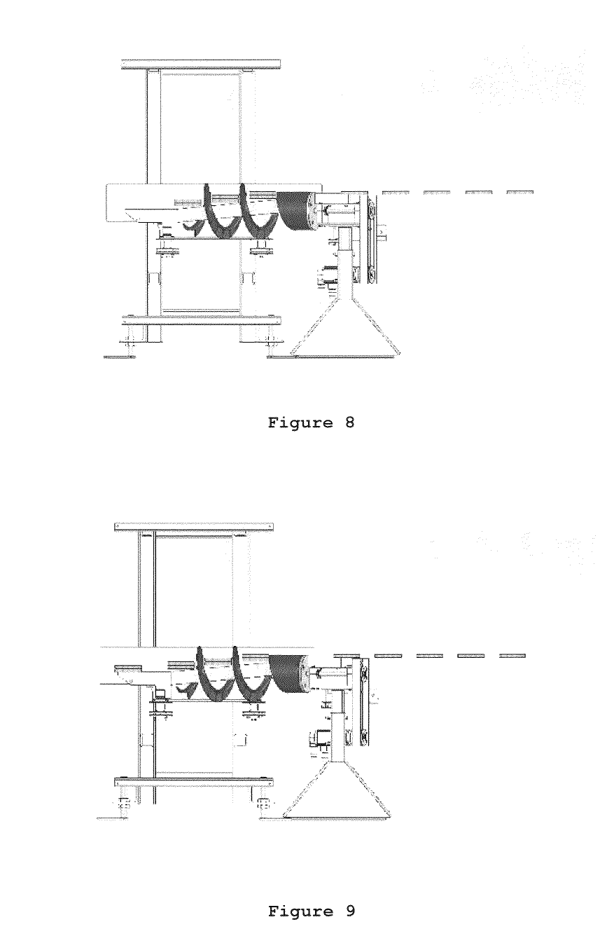

The helix or spiral member 20 consists of a circular rod 22 with the majority of the surface S removed in a spiral fashion along the length of the rod. A simple example would be the body of a machine bolt with the head removed. The material removed creates an opening that boards can fall into. The opening can be visualized as a valley between two peaks. The valley is the root diameter of the thread and the height of the peaks is the outer diameter of the bolt. The depth of the material removal between the peaks dictates the thickness of the board or boards that can sit in the valley. The tops of the peaks can be sharp, rounded or flat. The spacing of the spiral creates a valley of the proper width for the boards to be stacked between the peaks, as shown, for example, in FIG. 5. A conveyor moves the boards (with the length across the conveyor) to the beginning of the spiral member. The end of the conveyor is positioned so that the leading board slides over the first peak of the spiral into the first valley and stops moving forward. The second board catches up to the first board and slides on top of it as shown in FIG. 6. Depending on the difference in height between the top of the peak, the floor of the valley and the thickness of the board, a third or more boards can be allowed to stack on top of the first two boards. When the valley is full, the helix 20 is rotated one revolution to move the stack of boards forward and expose the next valley as shown in FIG. 7.

The outer surface of the helix 20 is shaped to perform two functions. First to provide a ledge that will support the boards as they are accumulated and fall away when the mini stack is complete. Then to present a surface for the first board to rest on while the helix is rotated to present the next valley. This reduces the speed necessary to position the next valley. The pass line of the conveyor is at or above the outer diameter of the helix. The end of the conveyor is positioned before the first valley of the helix. A transition is required between the diameter of the infeed conveyor pulley and the outer diameter of the first peak. A passive ramp or a driven member is required to move the board into the valley before the next board arrives.

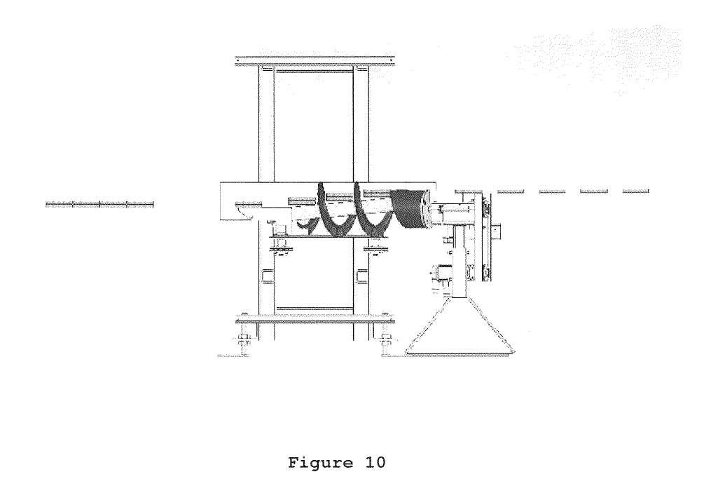

The single mini stack is now controlled between the peak in front and pushed by the one behind. The pitch of the helix downstream is changed aligning the edges of the stack on the front (downstream side) and pushing the stack forward from the rear. The helix may need to be designed for the width of the boards to be mini stacked depending on the acceleration of the rotation. As more stacks are created at the base of the helix, the downstream spiral is filled with completed stacks as shown in FIG. 9. The aligned stacks are discharged onto a downstream conveyor in groups of stacks. The stacks travel on the downstream conveyor to a stop or the end with the edges of the boards in one stack touching the edges of the boards in the following stack as they stop moving as shown in FIG. 10.

Creating a layer for stacking that contains multiple stacks of boards allows the positioning of the multi-board layer at a lower velocity. The positioning of stacks next to each other in a layer means the length of the layer is more accurate and less variable. With individual waney boards that can overlap each other the length of the layer will be shorter due to the overlap or longer because of an extra board in the layer. By having two or more boards in each stack, the probability of one or more overlaps in a multi-stack layer is very small. The positioning of stacks side by side also means that individual boards will not overlap or slide on top of each other creating a layer with a variable thickness.

The helix or spiral member can be made from a tube or pipe instead of a solid rod or welded body. A ramp inside the helix then creates the floor of the valley. The distance from the helix outer diameter to the ramp can be adjustable so that the desired number of boards which can fill the valley can be changed.

The goal is to consistently move and stack as many boards as possible as fast as possible. As the speed of the boards moving from the end of the conveyor to the first valley in the mini stacker is increased, there is a greater need to control the spacing between incoming boards. To achieve maximum efficiency and productivity with the mini stacker, the incoming stream of boards must be timed and spaced so that the next valley can be put into position before another board arrives and stops on or overshoots the stack in the first full valley.

A simple method would be to use a ramp to accelerate the speed of the board into the spiral so more time is available to rotate the next valley into position.

A method available for high speeds would be to make an incoming “smart” conveyor system capable of detecting the position of a board, calculating its required position in the stream of boards approaching the first valley of the mini-stacker and accelerating or decelerating that board into the optimum position.

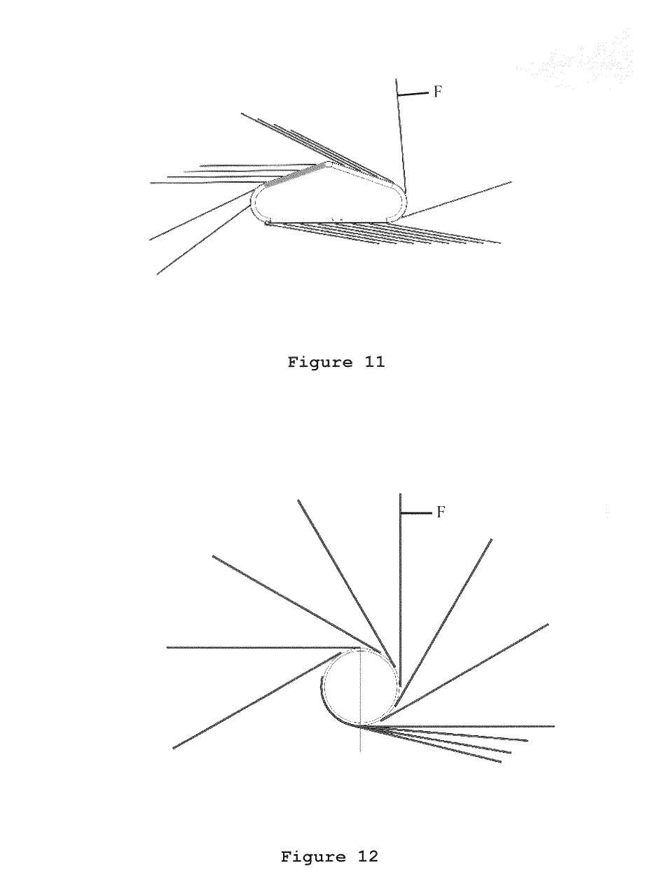

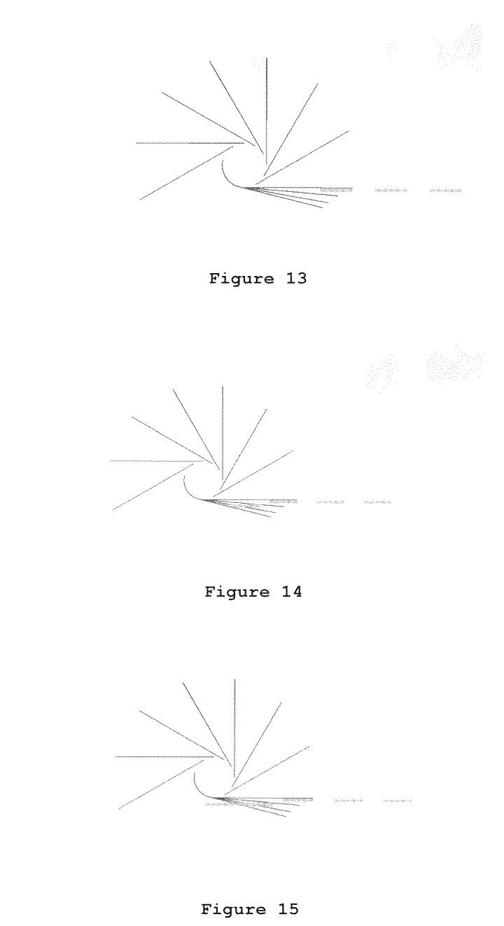

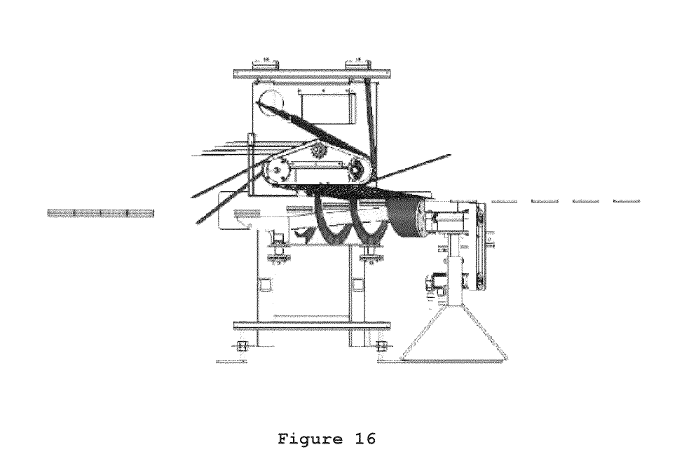

Another method for high speeds is to use a flap wheel as shown in FIGS. 12-15 or flap track as shown in FIG. 11 to space and control the boards as they approach the first valley of the mini stacker as shown in FIG. 15. The wheel or track has multiple flexible flaps F that move along from the end of the infeed conveyor to the end of the helix. The flap wheel or track above the spiral member turns at a speed to place one flap on top of each board as it advances onto the beginning surface of the spiral. If a board is in position, the flap on top of the board holds it in contact with the conveyor underneath so that it cannot slip. The flap then pulls the board over the transition from the conveyor to the beginning of the spiral as shown in FIG. 13. The flap also pushes the board down into the valley when it has moved forward past the first peak of the spiral. If a board is not present, then the flap just slides forward over the outer diameter of the spiral. The end of each flap keeps the next board from climbing on top of the preceding board until it is in the valley of the helix. The advancing flap also helps move each board forward and on top of the preceding board that has already settled into the valley. The speed ratio between the spiral and the flap mechanism is adjusted to match the number of boards stacked into each valley. The flap mechanism also meters the infeed stream of boards into the spiral entrance without flooding the outside surface of the helix and pushing boards past the valleys without falling in.

Alternate methods for high speed could use a tire or driven wheel assemblies above and in contact with the boards. A combination of any of these methods could be used to achieve the highest speeds.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claim.

1. An apparatus to build individual stacks of boards and collect them as a layer from a stream of single boards inline with a conveyor or other equipment comprising a spiral at the end of the conveyor or other equipment for receiving the single boards, the spiral having a first valley and a first and second peak adjacent each side of the first valley, the first valley adapted to receive two or more single boards in stacked relation, wherein the spiral is adapted to be rotated to move the two or more single boards downstream and provide a second valley and a third and fourth peak adjacent each side of the second valley for receiving an additional two or more single boards in stacked relation, wherein at the end of the spiral multiple groups of the two or more stacked boards are positioned for forming a layer of stacked boards.

2. The apparatus of claim 1 wherein the spiral peaks are parallel or symmetrically opposed to each other.

3. The apparatus of claim 2 wherein the spiral is counter-rotating.

4. The apparatus of claim 1 wherein the spiral is combined with either or all of an inclined ramp, a flap system, a rotating tire, and a driven set of wheels to assist the transfer of the single boards from the conveyor.

5. The apparatus of claim 1 wherein the tops of the peaks are sharp, round or flat.

6. The apparatus of claim 1 wherein the valleys and the peaks are sized to receive different sizes of boards.

7. The apparatus of claim 1 wherein the pitch of the spiral downstream changes aligning the edges of the stack on the downstream side and pushing the stack forward from the upstream side.

8. The apparatus of claim 1 wherein the spiral is formed from a tube, a pipe or a solid rod.

9. A method of building individual stacks of boards and collecting them as a layer from a stream of single boards in the same orientation and direction positioned between a board feeding apparatus and a board handling apparatus comprising the steps of:
(a) moving single boards on a first conveyor from the board feeding apparatus to a spiral apparatus;
(b) the spiral apparatus receiving the single boards, the spiral apparatus comprising a first valley and a first and second peak adjacent each side of the first valley, the first valley adapted to receive two or more single boards in stacked relation, wherein the spiral is adapted to be rotated to move the two or more single boards downstream and provide a second valley and a third and fourth peak adjacent each side of the second valley for receiving an additional two or more single boards in stacked relation; and
(c) moving the two or more stacks of single boards to a second conveyor to move the two or more stacks of boards to the board handling apparatus.

10. The method of claim 9 wherein the board feeding apparatus is a board unscrambler.

11. The method of claim 10 wherein the board handling apparatus is a stacking machine.

12. The method of claim 11 wherein the boards are boards for making a pallet.
